(19) United States
(12) Patent Application Publication
(10) Pub. No.: US 2009/0162225 A1
(43) Pub. Date: Jun. 25, 2009

(54) PUMP FOR LIQUID COOLING SYSTEM

(75) Inventors: CHENG-TIEN LAI, Tu-Cheng (TW); ZHI-YONG ZHOU, Shenzhen (CN); QIAO-LI DING, Shenzhen (CN)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 11/961,344

(22) Filed: Dec. 20, 2007

(51) Int. Cl. F04D 13/08; H02K 5/132; F04D 7/04; H02K 16/04

(52) U.S. Cl. 417/423.3; 310/54; 310/87; 310/254; 310/257; 417/423.7; 417/423.14

(57) ABSTRACT

A pump comprises a base (10), a case (20) fixed on the base, a rotor (30) received between the case and the base, and an inner stator (40) and an outer stator (50) accommodated in the case. The rotor is sandwiched between the inner stator and the outer stator. When the inner stator and the outer stator are energized to generate respective magnetic fields, the rotor is driven to rotate by turning torques that are produced by mutual actions between the rotor and the magnetic fields. Thus, the interior and exterior magnetic fields of the rotor can be utilized sufficiently, and an operation efficiency of the pump is enhanced accordingly.

### BACKGROUND OF THE INVENTION

1. Field of the Invention

The present invention relates to a pump, and more particularly to a pump incorporating a pair of stators for enhancing an operating efficiency thereof.

2. Description of Related Art

With continuing development of the computer technology, electronic packages such as the CPUs are generating more and more heat that is required to be dissipated immediately. The conventional heat dissipating devices such as combined heat sinks and fans are not competent for dissipating so much heat any more. Liquid cooling systems have thus been increasingly used in computer technology to cool these electronic packages.

A typical liquid cooling system comprises a heat absorbing unit for absorbing heat from a heat source, and a heat dissipating unit which is filled with liquid. The liquid conducts heat exchange with the heat absorbing unit, thereby taking away the heat from the heat absorbing unit when the liquid is circulated. Typically, a miniature pump is used to circulate the liquid in the liquid cooling system.

A conventional pump comprises a case, a stator secured in the case, and a rotor rotatably mounted in the case and enclosing the stator. When an electric current is delivered to armature coils of the stator, an alternating magnetic field is produced from the stator, and interacts with another magnetic field generated by a permanent magnetic sleeve of the rotor, to repulse or attract the permanent magnetic sleeve to rotate, whereby the pump starts working.

The another magnetic field produced by the permanent magnetic sleeve simultaneously distributes at an interior and an exterior of the rotor. However, the alternating magnetic field produced by the rotor can only interact with the interior part of the another magnetic field, which results in the exterior part of the another magnetic field being wasted. Hence, the another magnetic filed is not able to be utilized sufficiently, and an operating efficiency of the motor is thus limited accordingly.

What is needed, therefore, is a pump with two stators which can overcome the above-mentioned disadvantage.

### SUMMARY OF THE INVENTION

A pump comprises a base, a case fixed on the base, a rotor received between the case and the base, and an inner stator and an outer stator accommodated in the case. The rotor is sandwiched between the inner stator and the outer stator. When the inner stator and the outer stator are energized to generate respective magnetic fields, the rotor is driven to rotate by turning torques that are produced by mutual actions between the rotor and the magnetic fields. Thus, the interior and exterior magnetic fields of the rotor can be utilized sufficiently, and an operation efficiency of the pump is enhanced accordingly.

Other advantages and novel features of the present invention will become more apparent from the following detailed description when taken in conjunction with the accompanying drawings, in which:

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an assembled, isometric view of a pump in accordance with a preferred embodiment of the present invention;

FIG. 2 is an exploded view of FIG. 1;

FIG. 3 is a view similar to FIG. 1 with a cover and a printed circuit board being hidden;

FIG. 4 is a vertical sectional view of FIG. 1;

FIG. 5 is a view of an operation principle of the pump of FIG. 1; and

FIG. 6 is a view of an operation principle of another pump in accordance with another embodiment of the present invention.

### DETAILED DESCRIPTION OF THE INVENTION

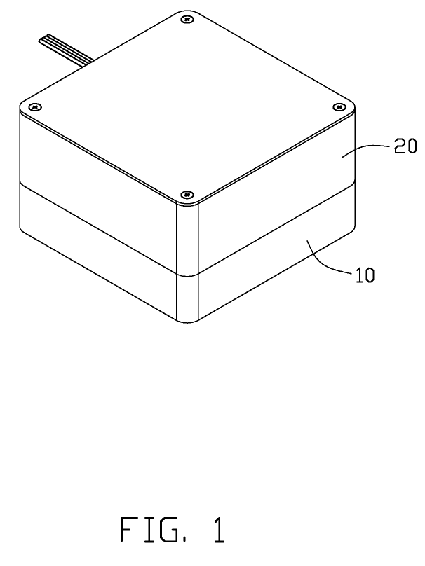

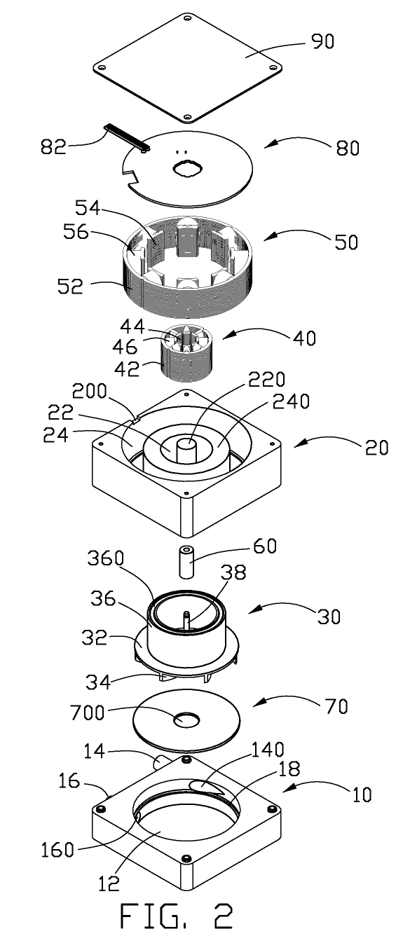

Referring to FIGS. 1 and 2, a pump in accordance with a preferred embodiment of the present invention is used in a liquid cooling system (not shown) for driving liquid to flow. The pump comprises a base 10, a case 20 fixed on the base 10, a rotor 30 received between the case 10 and the base 20, an inner stator 40 received into the case 20 and surrounded by the rotor 30, an outer stator 50 accommodated in the case 20 and surrounding the rotor 30, and a cover 90 fixed on the case 20 to overlay the inner stator 40 and the outer stator 50.

The base 10 has a substantially square shape with a circular hole 12 defined in a central area from a top to a bottom thereof. A first pipe 14 and a second pipe 16 are formed horizontally and outwardly from a sidewall (not labeled) of the base 10, wherein the first pipe 14 is located at an upper portion of the base 10, and the second pipe 16 is located at a lower portion of the base 10. Each of the first pipe 14 and the second pipe 16 has a perforation 140, 160 communicating with the circular hole 12. The first pipe 14 functions as a water-inlet which allows the liquid flowing into the pump therethrough, and the second pipe 16 acts as a water-outlet which allows the liquid flowing away the pump therethrough. An annular step 18 is formed at a middle of a height of the base 10 and around an inner circumference of the base 10 for supporting an annulus 70 thereon.

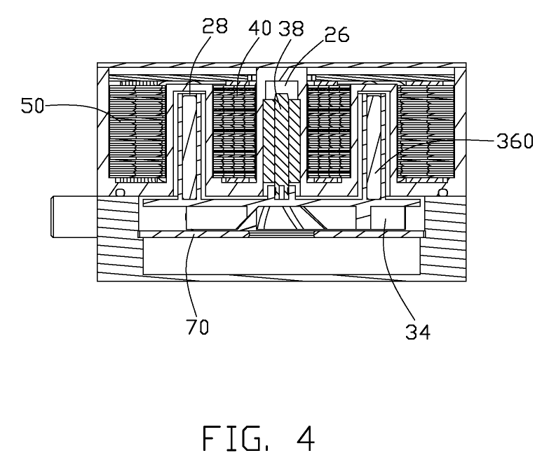

Also viewed from FIG. 4, the case 20 is fixed on the base 10 by bringing four screws (not shown) to extend four corners of the case 20 and be threadedly engaged in the base 10. The case 20 also has a square configuration that has a cross-section identical to that of the base 10. An annular area of a top face of the case 20 is concaved downwardly to form an annular first cavity 22; another annular area of the top face of the case 20 having an interior diameter larger than an exterior diameter of the annular area, is concaved downwardly to form an annular second cavity 24, wherein the first cavity 22 surrounds a cylindrical post 220 in a central area of the case 20, and the first cavity 22 and the second cavity 24 cooperatively form an annular protrusion 240 coaxially surrounding the post 220. A circular area of a bottom face of the case 20 that has a diameter less than that of the post 220 is concaved upwardly to form a circular third cavity 26 (illustrated in FIG. 4), thereby enabling the post 220 to be hollow; an additional annular area of the bottom face of the case 20 that has an interior diameter larger than that of the annular protrusion 240 and an exterior diameter less than that of the annular protrusion 240, is concaved upwardly to form an annular forth cavity 28 (illustrated in FIG. 4), thus enabling the annular protrusion 240 to be hollow, too. The first cavity 22 and the second cavity 24 have openings (not labeled) oriented upwardly, and the third cavity 26 and the forth cavity 28 have openings (not labeled) oriented downwardly, in other words, an interior of the case 20 is separated into two spaces by an interlayer (not labeled), which is constituted by the hollow post 220, the hollow annular protrusion 240 and other parts of the case 20 within an outer circumference of the second cavity 24. Thus, when the liquid is transferred into the case 20, it will be prevented from flowing into the first cavity 22 and the second cavity 24 for isolating the inner stator 40 and the outer stator 50 from the liquid. A height of the hollow post 220 is identical to that of the case 20; a height of the hollow annular protrusion 240 is less than that of the hollow post 220 for allowing a printed circuit board 80 disposed thereon. A cutout 200 is defined in a sidewall of the case 20 corresponding to the first pipe 14 on the base 10, for providing a passage of power cords 82 of the printed circuit board 80.

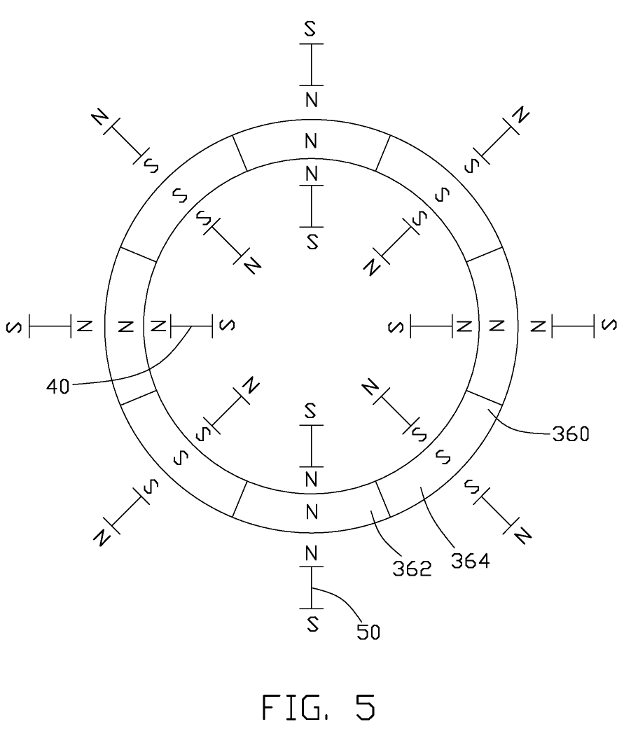

As shown in FIGS. 2, 3 and 5, the rotor 30 is sandwiched between the case 20 and the base 10. The rotor 30 comprises a circular panel 32, a plurality of blades 34 raidally attached on a bottom face of the circular panel 32, a pair of coaxial sidewalls 36 extending upwardly and vertically from a top face of the circular panel 32, and a shaft 38 extending upwardly and perpendicularly from the top face of the circular panel 32 and enclosed by the pair of coaxial sidewalls 36. The plurality of blades 34 is for being received in the circular hole 12 of the base 10 and located above the annulus 70, they agitate the liquid to enter into the pump via the water-inlet, to thereby drive the liquid to flow in a downwardly volute manner through a hole 700 of the annulus 70, and away from the pump via the water-outlet. A permanent magnetic sleeve 360 having alternating N and S magnetic poles 362, 364, is sandwiched between the pair of coaxial sidewalls 36 (shown in FIG. 5), wherein each of the N magnetic poles 362 is located adjacent to each of the S magnetic poles 364 and has an angular width of 360/N degrees (N is a total number of the N and S magnetic poles 362, 364). The permanent magnetic sleeve 360 produces a magnetic field that has a part distributed inside of the rotor 30, and another part distributed outside of the rotor 30, for interacting with the inner stator 40 and the outer stator 50, respectively. A bearing 60 is sleeved onto the shaft 38 of the rotor 30 for supporting the rotor 30 when the bearing 60 is accommodated in the third cavity 26 of the case 20, and the pair of coaxially sidewalls 36 are received in the forth cavity 28 of the case 20.

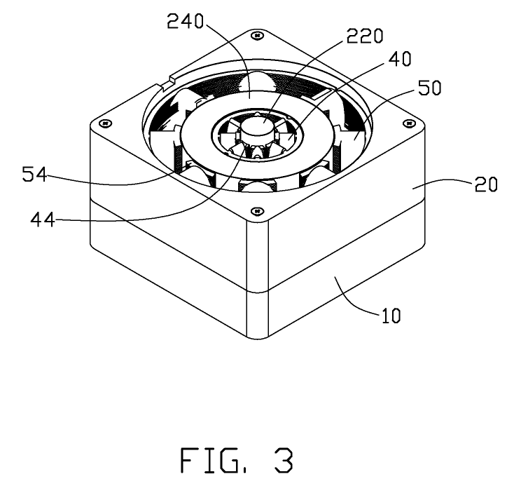

Also referring to FIGS. 3-4, the inner stator 40 and the outer stator 50 are for being received in the case 20. Each of the inner stator 40 and the outer stator 50 comprises a plurality of yokes 42, 52 stacked with each other, a plurality of teeth (not labeled) extending inwardly from and equidistantly around inner peripheries of the plurality of yokes 42, 52, and a plurality of armature coils 46, 56 respectively wound spirally onto necks of the plurality of teeth. The plurality of armature coils 46 of the inner stator 40 have different spirally wound configurations with respect to the plurality of armature coils 56 of the outer stator 50, whereby the inner stator 40 and the outer stator 50 produce opposite magnetic fields. Each of the plurality of teeth forms a piece 44, 54 at an extremity end thereof, which is wider than the neck of the each of the plurality of teeth for producing more uniform magnetic field as the plurality of armature coils 46, 56 is energized. The pieces 44, 54 of the each of the inner stator 40 and the outer stator 50 are distributed in a circumferentially, equidistantly spaced relationship around an inner circumference thereof, and have a number identical to that of the N and S magnetic poles 362, 364 of the magnetic sleeve 360 of the rotor 30. The inner stator 40 is received in the first cavity 22 of the case 20 with the pieces 44 thereof around the hollow post 220, and the plurality of yokes 42 thereof contacting an inner periphery of the hollow annular protrusion 240 of the case 20; the outer stator 50 is received in the second cavity 24 of the case 20 with the pieces 54 thereof around an outer periphery of the hollow annular protrusion 240, and the plurality of yokes 52 contacting the outer periphery of the second cavity 24 of the case 20. The inner stator 40 and the outer stator 50 are so arranged that each of the teeth of the inner stator 40 is opposing to each of the teeth of the outer stator 50.

The printed circuit board 80 is disposed on the hollow annular protrusion 240 and in the second cavity 24 of the case 20 and sleeved on a top of the hollow post 220, with its power cords 82 extending through the cutout 200 of the case 20. The printed circuit board 80 electrically connects the inner stator 40 and the outer stator 50 with a power source (not shown), for providing alternating electric current to the inner stator 40 and the outer stator 50.

The cover 90 firmly couples with the case 20 by the screws to overlay the printed circuit board 80. The cover 90 is used for protecting the inner elements of the pump.

As shown in FIGS. 2 and 5, in use of the pump, the alternating electric current provided by the printed circuit board 80 flows through the plurality of armature coils 46, 56 to make the plurality of armature coils 46, 56 to generate magnetic fields (it is called magnetic effect of electric current). Since the different spiral wound configurations of the plurality of armature coils 46, 56 of the inner stator 40 and the outer stator 50, each of the teeth of the inner stator 40 has opposite polarities relative to an adjacent one of the teeth of the inner stator 40, and also an opposing one of the plurality of teeth of the outer stator 50. For example, when predetermined electric current is delivered to the inner stator 40 and the outer stator 50, one of the plurality of teeth of the inner stator 40 is magnetized in a manner such that an inner end thereof exhibits an N polarity, and an outer end thereof exhibits an S polarity, thereby defining a first magnetic field having a radially outward orientation; the opposing one of the plurality of teeth of the outer stator 50 is magnetized in a manner such that an inner end thereof presents an N polarity, and an outer end thereof presents an S polarity, thereby defining a second magnetic field having a radially inward orientation. The first magnetic field interacts with the inner part of the magnetic field produced by the permanent magnetic sleeve 360 to generate an inner turning torque, which repulses the N magnetic pole 362 of the permanent magnetic sleeve 360 to render the rotor 30 to rotate anticlockwise; the second magnetic field interacts with the outer part of the magnetic field produced by the permanent magnetic sleeve 360 to generate an outer turning torque, which has an orientation equal to that of the inner turning torque and also repulses the N magnetic pole 362 of the permanent magnetic sleeve 360 to make the rotor 30 rotate anticlockwise, too. As the rotor 30 rotating, a frequency of the alternating current changing its direction is synchronized with rotating velocities of the inner stator 40 and the outer stator 50, thereby to ensure the inner turning torque and the outer turning torque pushing the rotor 30 to rotate continuously. Due to a resultant torque formed by the inner turning torque and the outer turning torque being larger than a single one of the inner turning torque and the turning outer torque, the rotor 30 is capable of being driven to have a high speed rotation. Therefore, the magnetic field generated by the permanent magnetic sleeve 360 can be utilized sufficiently, and the operation efficiency of the pump is enhanced, accordingly.

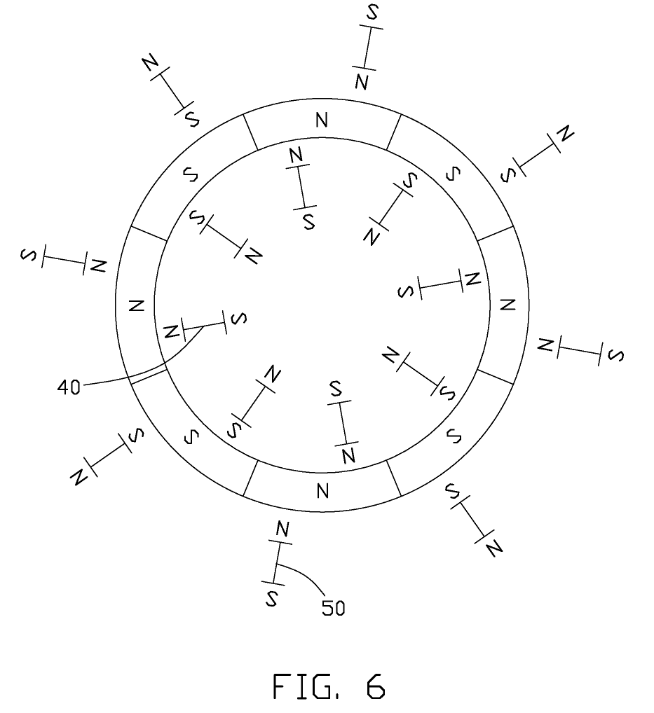

Referring to FIG. 6, it can be understood, in order to resolve a problem of “dead point”, which may cause the pump is not able to start itself, the inner stator 40 can be staggered with the outer stator 50, with the each of the plurality of teeth of the inner stator 40 defining an acute angle with a corresponding one of the plurality of teeth of the outer stator 50.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A pump for a liquid cooling system comprising:
a base;
a case fixed on the base;
a rotor received between the base and the case, comprising a magnetic sleeve accommodated in the case;
an inner stator received in the case and surrounded by the magnetic sleeve of the rotor; and
an outer stator received in the case and surrounding the magnetic sleeve of the rotor, the inner stator and the outer stator being separated from the rotor by an interlayer formed in the case, wherein when the inner stator and the outer stator are energized, an inner magnetic field produced by the inner stator and an outer magnetic field produced by the outer stator interact with the magnetic sleeve to together drive the rotor to rotate.

2. The pump as claimed in claim 1, wherein the rotor comprises a circular panel and a plurality of blades raidally attached on a bottom face of the circular panel, the plurality of blades and the circular plate being received in the base.

3. The pump as claimed in claim 2, wherein the rotor further comprises a pair of coaxial sidewalls extending upwardly from the a top face of the circular panel, and a shaft formed upwardly from the top face of the circular panel and surrounded by the pair of coaxial sidewalls, the magnetic sleeve being sandwiched between the pair of coaxial sidewalls.

4. The pump as claimed in claim 3, wherein the case defines a circular cavity opened downwardly, and an annular cavity opened downwardly and surrounding the circular cavity, the shaft being received in the circular cavity and the pair of coaxial sidewalls being received in the annular cavity.

5. The pump as claimed in claim 4, wherein the case defines an annular chamber opened upwardly, and another annular chamber opened upwardly and surrounding the annular chamber, the inner stator being received in the annular chamber and the outer stator being received in the another annular chamber.

6. The pump as claimed in claim 5, wherein the annular chamber of the case surrounds the circular cavity and is surrounded by the annular cavity, and the another annular chamber surrounds the annular cavity.

7. The pump as claimed in claim 2, wherein the base defines a transverse hole in an upper portion thereof, a horizontal hole in a lower portion thereof, and a upright hole from a top to a bottom thereof, the upright hole communicating the horizontal hole with the transverse horizontal hole and receiving the plurality of blades of the rotor therein.

8. The pump as claimed in claim 7 further comprises an annulus received in the upright hole and at a middle of a height of the base to separate the horizontal hole with the transverse hole of the base, wherein the rotor is located above the annulus.

9. The pump as claimed in claim 1, wherein the magnetic sleeve has a plurality of alternating N and S poles, each of the inner stator and the outer stator comprising circumferentially distributed teeth having a number identical to that of the plurality of alternating N and S poles of the magnetic sleeve.

10. The pump as claimed in claim 9, wherein each of the teeth of the inner stator is opposing to each of the teeth of the outer stator, the each of the teeth of the inner stator having opposite polarities relative to that of the each of the teeth of the outer stator.

11. The pump as claimed in claim 9, wherein each of the teeth of the inner stator is staggered with each of the teeth of the outer stator.

12. A pump for a liquid cooling system comprising:
a base;
a case secured on the base, the case comprising an interlayer to separate an interior thereof to a first space and a second space;
a bearing being received within the first space of the case;
a rotor being received between the base and the case, the rotor comprising a shaft being supported by the bearing, and a magnetic sleeve enclosing the shaft, the magnetic sleeve being received in the first space of the case;
an inner stator being received in the second space of the case and surrounded by the magnetic sleeve of the rotor; and
an outer stator being received in the second space of the case and around the magnetic sleeve of the rotor, wherein the outer stator and the inner stator generate turning torques having same orientations to act on the rotor, thereby driving the rotor to rotate.

13. The pump as claimed in claim 12, wherein the first space of the case has an opening oriented downwardly, and the second space of the case has an opening oriented upwardly.

14. The pump as claimed in claim 12, wherein each of the inner stator and the outer stator comprises a plurality of yokes stacked with each other, a plurality of teeth extending inwardly from inner peripheries of the plurality of yokes, and a plurality of armature coils wound on the plurality of teeth respectively.

15. The pump as claimed in claim 14, wherein each of the plurality of teeth of the inner stator faces each of the plurality of teeth of the outer stator, the each of the plurality of teeth of the inner stator having opposite magnetic poles with respect to that of an adjacent one of the plurality of teeth of the inner stator.

16. The pump as claimed in claim 14, wherein each of the plurality of teeth of the inner stator is staggered with each of the plurality of teeth of the outer stator.

17. The pump as claimed in claim 14, wherein a spirally wound configuration of the coils on each of the plurality of teeth of the inner stator is opposite to that of the coils of an opposing one of the plurality of teeth of the outer stator.

18. A liquid pump, comprising:
a casing defining therein a chamber, an inlet and an outlet both being in flow communication with the chamber;
a rotor received in the chamber and being rotatable to drive liquid to enter the chamber via the inlet and to exit the chamber via the outlet, the rotor comprising a cylindrical outer wall and a substrate connecting with a bottom end of the outer wall, an agitator being formed on a bottom surface of the substrate;
an inner stator and an outer stator received in the chamber to drive the rotor to rotate, wherein the inner stator located at an inner space of the outer wall of the rotor and the outer stator surrounds the outer wall of the rotor;
a partition seat received in the chamber and arranged between the inner and outer stators and the rotor to space the inner and outer stators and the rotor; and
a top cover mounted to a top of the casing.

19. The liquid pump as described in claim 18, wherein a magnetic ring having a plurality of alternating N and S poles is embedded in the outer wall of the rotor.
